(19) United States
(12) Patent Application Publication
(10) Pub. No.: US 2014/0126875 A1
(43) Pub. Date: May 8, 2014

(54) CONNECTOR FERRULE HOLDER

(71) Applicant: Lou Guzzo, Inman, SC (US)

(72) Inventor: Lou Guzzo, Inman, SC (US)

(73) Assignee: AFL TELECOMMUNICATIONS LLC, Duncan, SC (US)

(21) Appl. No.: 14/006,607

(22) PCT Filed: Mar. 21, 2012
(86) PCT No.: PCT/US2012/029917

§ 371 Date: Jan. 24, 2014

Related U.S. Application Data
(60) Provisional application No. 61/466,215, filed on Mar. 22, 2011.

(51) Int. Cl. G02B 6/24; G02B 6/46

(52) U.S. Cl. CPC G02B 6/241; G02B 6/46
USPC 385/139; 29/428

(57) ABSTRACT

A coupling including an adapter cap end and ferrule dust cap end is provided. The coupling may be used to store disconnected fiber optic lines in physical proximity to their assigned output by using a method of storing a fiber optic network connector. The method includes installing the coupling into a fiber optic network adapter by plugging the adapter cap end into the fiber optic network adapter; and installing the fiber optic network connector into the ferrule dust cap end of the coupling.

### CROSS-REFERENCE TO RELATED APPLICATIONS

This Application is based upon and claims priority from U.S. Provisional Application No. 61/466,215, filed on Mar. 22, 2011 in the United States Patent and Trademark Office, the entire contents of which are hereby incorporated herein in its entirety by reference.

### BACKGROUND

1. Field

Methods and apparatuses consistent with aspects of the exemplary embodiments relate to an adapter and ferrule dust caps.

2. Related Art

As Passive Optical Networks (PONs) are more widely deployed by telecommunications service providers, fiber optic lines are assigned to specific customers at a point-of-service in order to connect customers to the service. In some multi-dwelling units, a telecommunication service provider will pre-assign dedicated fiber optic lines to a specific dwelling. When service is ported to a specific customer by a telecommunications service provider, the service provider physically connects a fiber optic line at the point of service and electronically ports its backbone switching to provide service to the customer through the fiber optic line. Before a customer initiates service or after a customer cancels service, the physical connection at the point of service is disconnected, and the backbone switching is reported.

The current practice is to store connectors in a “parking lot” or holder within a cabinet or enclosure, see e.g. U.S. Pat. Nos. 7,218,827 and 7,407,330. This methodology is efficient in a partially filled (connected) cabinet. However, when a cabinet or enclosure is densely populated, it may be cumbersome to disconnect a fiber optic line, and find and route the terminated fiber optic line back to the correct centralized connector parking area without causing possible service interruptions. Thus, there is a need for a solution that eliminates a “parking lot” and allows a service provider to store a fiber optic line connector in an adapter at the point of service.

### SUMMARY

According to an aspect of an exemplary embodiment, a coupling includes: an adapter cap end and a ferrule dust cap holder end that enables the storage of a disconnected fiber optic line in physical proximity to its assigned output. The adapter cap end and ferrule dust cap end may be disposed in the same plane.

According to an aspect of an exemplary embodiment, the adapter cap end may include a subscriber Connector/Square Connector/Standard Connector (SC) adapter cap. The adapter cap end may also include a push-pull coupling which snaps into the opening on an SC adapter with a snap connector. The ferrule dust cap end may include a 2.5 mm T-style dust cap which fits onto a 2.5 mm ferrule of an SC connector.

According to an aspect of an exemplary embodiment, the adapter cap end may include a Ferrule Connector/Fiber Channel (FC) adapter cap. The adapter cap end may also include a screw connector which screws to an opening on an FC adapter with a screw connector. The ferrule dust cap end 3 may include a 2.5 mm dust cap end which screws to an FC connector with a 2.5 mm ferrule.

According to an aspect of an exemplary embodiment, the adapter cap end may include a Lucent Connector/Little Connector/Local Connector (LC) adapter cap. The adapter cap end may also include a snap connector which snaps to an LC adapter with a snap connector. The ferrule dust cap end may include a 1.25 mm dust cap end which snaps to an LC connecter with a 1.25 mm ferrule.

According to an aspect of an exemplary embodiment, the adapter cap end comprises a Straight Tip (ST) or a Bayonet Fiber Optic Connector (BFOC) adapter cap. The adapter cap end may also include a BFOC or a ST connector. The ferrule dust cap end may include a dust cap end which connects to an ST connector or a BFOC with a 2.5 mm ferrule.

According to an aspect of an exemplary embodiment, the coupling may be made of an opaque material, a translucent material, or a combination of both. The coupling may also be made of a polymeric material.

According to another aspect of an exemplary embodiment, a method for storing a fiber optic network connector includes installing a coupling into a fiber optic network adapter by plugging the adapter cap end of the coupling into the fiber optic network adapter; and installing the fiber optic network connector into the ferrule dust cap holder end of the coupling.

### BRIEF DESCRIPTION OF THE FIGURES

The above and/or other aspects will become apparent and more readily appreciated from the following description of the exemplary embodiments, taken in conjunction with the accompanying drawings, in which:

FIG. 1A is a drawing of a coupling with an adapter cap end and a ferrule dust cap end showing a perspective of the ferrule dust cap end of the coupling according to an aspect of an exemplary embodiment;

FIG. 1B is a drawing of a coupling with an adapter cap end and a ferrule dust cap end showing a perspective of the adapter cap end of the coupling according to an aspect of an exemplary embodiment;

FIG. 2 is a drawing of a connector connected to the ferrule dust cap end of the coupling according to an aspect of an exemplary embodiment;

FIG. 3 is a drawing of a connector connected to the ferrule dust cap end of the coupling and an adapter connected to the adapter cap end of the coupling according to an aspect of an exemplary embodiment; and

FIG. 4 is a drawing of four connectors connected to the ferrule dust cap end of four couplings and a bulkhead mounted with four adapters connected to the adapter cap ends of the four couplings according to an aspect of an exemplary embodiment.

FIG. 5 is a flowchart illustrating a method of storing a fiber optic network connector according to another aspect of an exemplary embodiment.

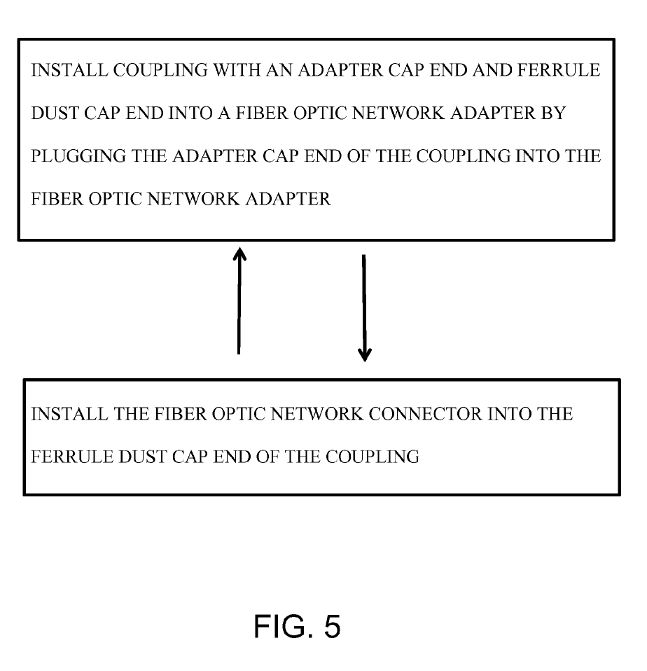

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

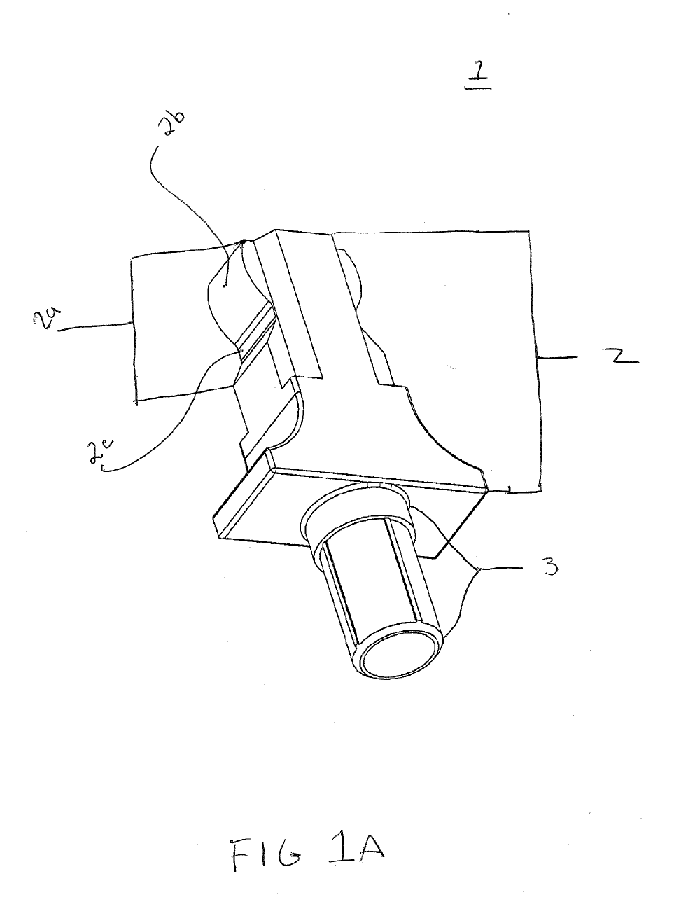

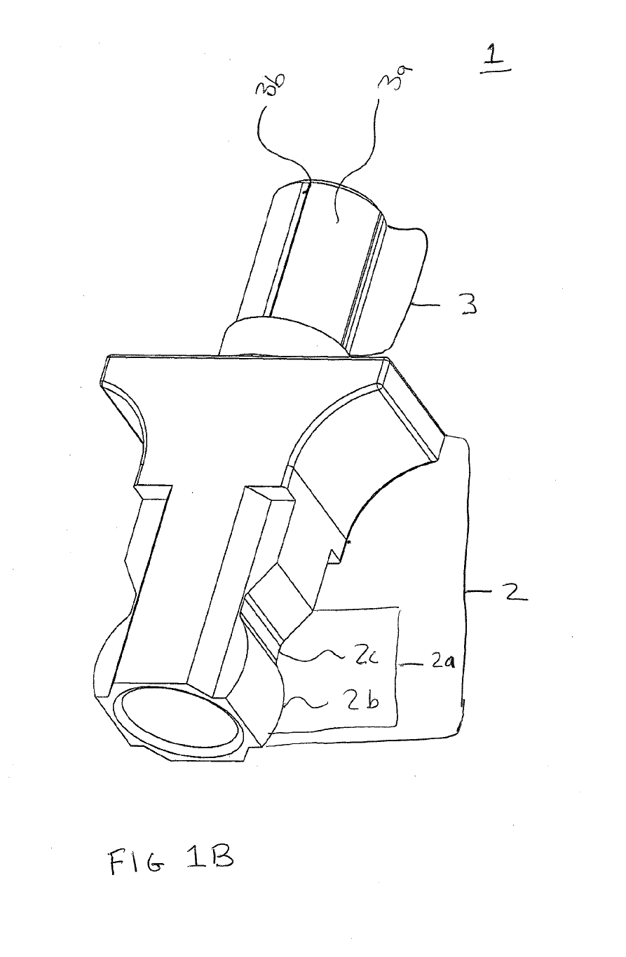

FIG. 1A shows a coupling 1 with an adapter cap end 2 and a ferrule dust cap/holder end 3 according to an aspect of an exemplary embodiment from a perspective of the ferrule dust cap/holder end 3. FIG. 1B shows coupling 1 with an adapter cap end 2 and a ferrule dust cap/holder end 3 according to an aspect of an exemplary embodiment from a perspective of the adapter cap end. A purpose of the adapter cap end 2 is to minimize the ingress of dust and airborne contaminants into the adapter interior and to allow the connector to be stored in an adapter, such as an adapter mounted in bulkhead instead of a separate connector “parking lot.”

The adapter cap end 2 may be a Subscriber Connector/Square Connector/Standard Connector (SC) adapter cap with push-pull coupling 2a which snaps into the opening on an SC adapter with a snap connector and a 2.5 mm ferrule diameter.

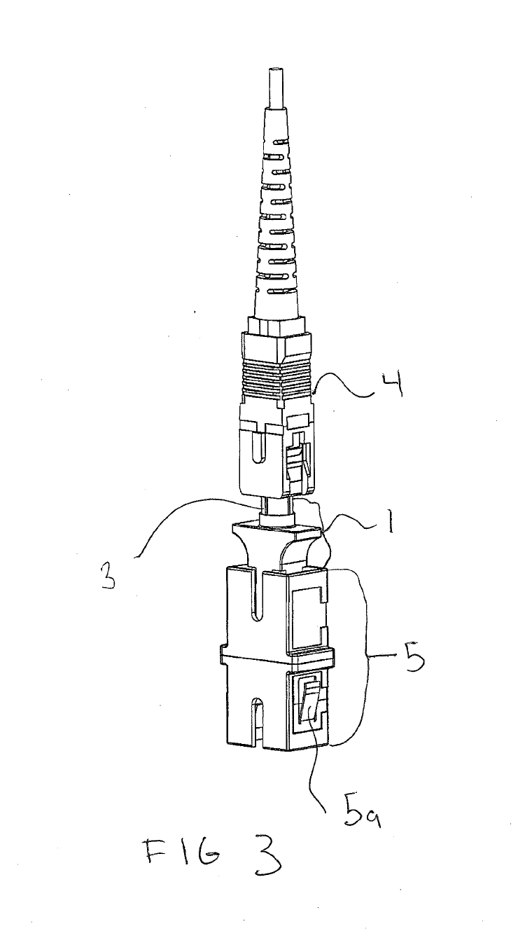

The push-pull coupling 2a according to an aspect of an exemplary embodiment may include a locking mechanism which securely locks the adapter cap end and the coupling into place when pushed into an adapter and unlocks the adapter cap end and the coupling when pulled from an adapter. An example locking mechanism comprises a semi-elliptical member 2b located at an edge of the push-pull coupling followed by a groove 2c. When the adapter cap end 2 is pushed into an adapter, locking arms 5a (see FIG. 3) slide over the semi-elliptical member 2b and securely lock into groove 2c. When the adapter cap end is pulled from an adapter, locking arms 5a (see FIG. 3) slide over the semi-elliptical member 2b releasing the adapter cap end and thus releasing the coupling from an adapter.

The adapter cap end 2 may also comprise a rectangular cover 2d which completely or partially covers an opening of an adapter 5 when the adapter cap end of the coupling is installed in an adapter. Other examples of covers may include circular and square covers.

The adapter cap end 2 may also be a Ferrule Connector/Fiber Channel (FC) with a screw connector which screws to the opening on an FC adapter with a screw connector and a 2.5 mm ferrule diameter.

The adapter cap end 2 may also be a Lucent Connector/Little Connector/Local Connector (LC) with a snap connector which snaps into the opening on an LC adapter with a snap connector and a 1.25 mm ferrule diameter.

The adapter cap end 2 may also be a Straight Tip/Bayonet Fiber Optic Connector (ST)/(BFOC) which connects to the opening on an ST/BFOC adapter with a bayonet connector and a 2.5 mm ferrule diameter.

The adapter cap end of the coupling may be embodied to cover and securely connect to other types of adapters. For example, the adapter cap end may be embodied as, but not limited to, a coaxial adapter cap, an RJ-11 adapter cap, an RJ-14 adapter cap, an RJ-45 adapter cap, etc.

The ferrule dust cap end 3 may be coupled to the ferrule of a connector. The purpose of the ferrule dust cap end 3 is to protect the ferrule end face from contaminant and mechanical damage. The ferrule dust cap end 3 may include a 2.5 mm T-style dust cap which fits onto the 2.5 mm ferrule of an SC connector.

The ferrule dust cap end 3 may comprise a cylindrical ferrule dust cap 3a which enables covers a ferrule of a fiber optic connector. The ferrule dust cap end 3 may also comprise a plurality of grooves 3b, which may be located at equidistant locations around the cylindrical ferrule dust cap 3a.

The ferrule dust cap end 3 may also include a dust cap which fits onto the 1.25 mm ferrule of an LC connector. Alternatively, the ferrule dust cap end 3 may include a 2.5 mm dust cap end which fits onto the 2.5 mm ferrule of an FC, ST, or BFOC connector.

The ferrule dust cap end of the coupling may be embodied to cover and securely connect to other types of connectors. For example, the dust cap end may be embodied as, but not limited to, a coaxial connector dust cap, an RJ-11 connector dust cap, an RJ-14 connector dust cap, an RJ-45 connector dust cap, etc.

The adapter cap end and ferrule dust cap end may be disposed in the same plane on the coupling. Further, the coupling may also comprise a plurality of adapter cap ends and ferrule dust cap ends.

The coupling 1 may be made from a polymeric material and may also be opaque. The coupling may attenuate a signal coming out of a connector to prevent possible eye damage to technicians in the field. The coupling may also be made out of a clear/translucent material or combination of opaque and clear/translucent material. In this case, a red light visible source could be used to trace fiber optic connectors in a panel.

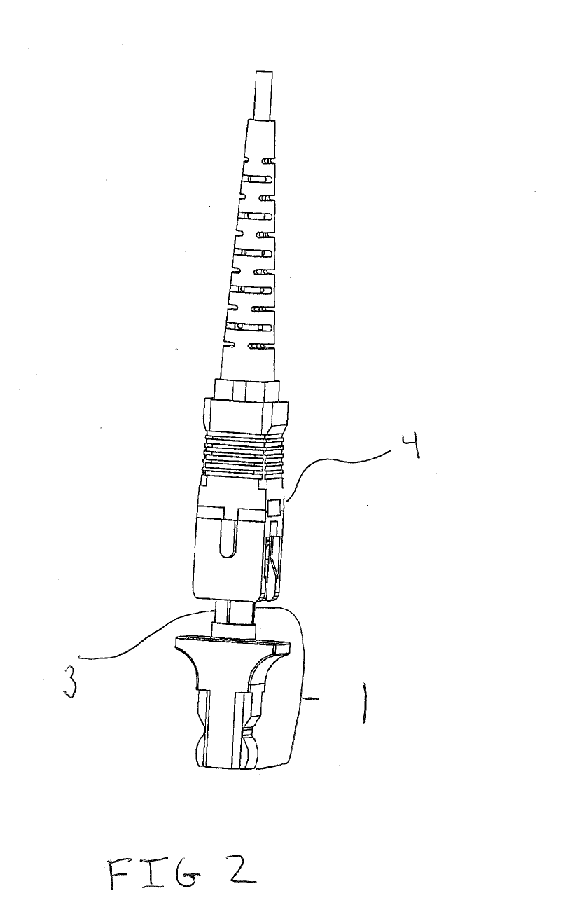

FIG. 2 shows a connector 4 connected to the ferrule dust cap end 3 of the coupling 1 according to an aspect of an exemplary embodiment.

FIG. 3 shows a connector connected to the ferrule dust cap end 3 of the coupling 1 and an adapter 5 connected to the adapter cap end 2 of the coupling 1 according to an aspect of an exemplary embodiment.

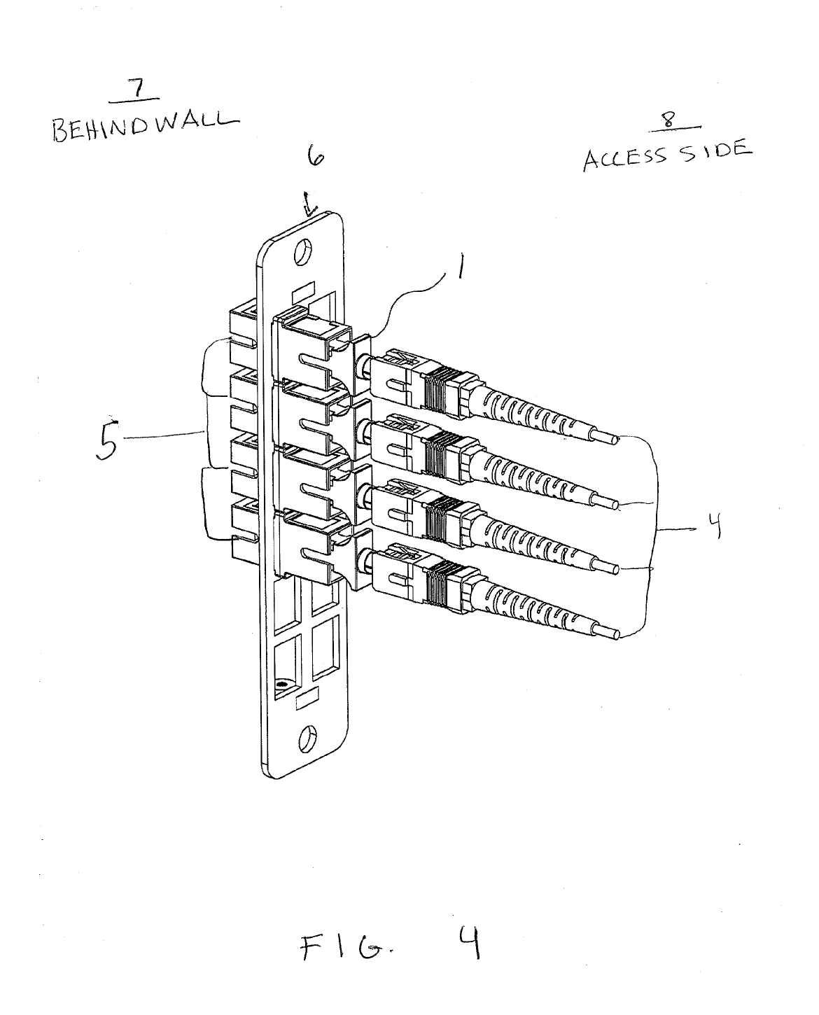

FIG. 4 shows four connectors 4 stored using four couplings 1 installed in a bulkhead 6 with four mounted adapters 5. A connector 4 may be installed in an adapter 5 on the access side 8. The adapter is partially located behind the wall 7.

When a connection is being made, a dust cap is removed from an adapter 5 opening and a connector 4 is inserted into the adapter 5 to complete the connection. When a connector 4 is to be removed and stored, a coupling 1 is plugged into an adapter 5 from which the connector 4 is removed using the adapter cap end 2 of the coupling 1, and connector 4 is plugged into ferrule dust cap end 3 of coupling 1, where connector 4 is stored.

Accordingly, the following advantages and benefits of the may be achieved by the exemplary embodiments. Connectors are stored at the expected point of use when not connected. This reduces the time for a telecommunication service provider technician to physically connect and/or disconnect service, and minimizes the risk of service disruption. The need for a connector parking lot is eliminated, which frees up cabinet space.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents. While the coupling is described above for use with fiber optic connectors and adapters, the inventive concept is not so limited. Rather, the coupling may be used with other types of connectors and adapters.

What is claimed is:

1. A coupling comprising:
an adapter cap disposed at a first end of the coupling; and
a ferrule dust cap disposed at a second end of the coupling.

2. The coupling of claim 1, wherein the adapter cap and ferrule dust cap are disposed in the same plane.

3. The coupling of claim 1, wherein the adapter cap end comprises a subscriber Connector/Square Connector/Standard Connector (SC) adapter cap.

4. The coupling of claim 3, wherein the adapter cap end further comprises a push-pull coupling which snaps into the opening on an SC adapter with a snap connector.

5. The coupling of claim 3, wherein the ferrule dust cap end comprises a 2.5 mm T-style dust cap which fits onto a 2.5 mm ferrule of an SC connector.

6. The coupling of claim 1, wherein the adapter cap end comprises a Ferrule Connector/Fiber Channel (FC) adapter cap.

7. The coupling of claim 6, wherein the adapter cap end further comprises a screw connector which screws to an opening on an FC adapter with a screw connector.

8. The coupling of claim 6, wherein the ferrule dust cap end 3 comprises a 2.5 mm dust cap end which screws to an FC connector with a 2.5 mm ferrule.

9. The coupling of claim 1, wherein the adapter cap end comprises a Lucent Connector/Little Connector/Local Connector (LC) adapter cap.

10. The coupling of claim 9, wherein the adapter cap end further comprises a snap connector which snaps to an LC adapter with a snap connector.

11. The coupling of claim 9, wherein the ferrule dust cap end comprises a 1.25 mm dust cap end which snaps to an LC connecter with a 1.25 mm ferrule.

12. The coupling of claim 1, wherein the adapter cap end comprises a Straight Tip (ST) or a Bayonet Fiber Optic Connector (BFOC) adapter cap.

13. The coupling of claim 12, wherein the adapter cap end further comprises a BFOC or a ST connector.

14. The coupling of claim 12, wherein the ferrule dust cap end comprises a dust cap end which connects to an ST connector or a BFOC with a 2.5 mm ferrule.

15. The coupling of claim 1, wherein the coupling comprises an opaque material.

17. The coupling of claim 1, wherein the coupling comprises a translucent material.

18. The coupling of claim 1, wherein the coupling comprises a polymeric material.

19. A method of storing a fiber optic network connector, the method comprising:
installing a coupling with an adapter cap end and ferrule dust cap end into a fiber optic network adapter by plugging the adapter cap end of the coupling into the fiber optic network adapter; and
installing the fiber optic network connector into the ferrule dust cap end of the coupling.
